(19) United States
(12) Patent Application Publication
(10) Pub. No.: US 2004/0266904 A1
(43) Pub. Date: Dec. 30, 2004

(54) Hydrated ultrahigh molecular weight polyethylene medical implant

(75) Inventors: Yen-Shuo Liao, Warsaw, IN (US); Mark D. Hanes, Winona Lake, IN (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: DePuy Products, Inc., Warsaw, IN

(21) Appl. No.: 10/609,742

(22) Filed: Jun. 30, 2003

(51) Int. Cl. C08L 1/00

(52) U.S. Cl. 522/161; 522/184; 522/189; 522/911; 522/912; 523/113; 523/115; 525/333.7

(57) ABSTRACT

The invention provides a sterile medical implant or medical implant part comprising ultrahigh molecular weight polyethylene that has a molecular weight of about 400,000 atomic mass units or more. The invention also provides methods for producing, using, and preparing a medical implant or medical implant part, which comprise contacting the medical implant or medical implant part with water, such that the weight of the ultrahigh molecular weight polyethylene is increased, and the wear performance of the medical implant or medical implant part desirably is enhanced.

### FIELD OF THE INVENTION

This invention pertains to medical implants comprised of ultrahigh molecular weight polyethylene and methods of producing and using same.

### BACKGROUND OF THE INVENTION

Ultrahigh molecular weight polyethylene (“UHMWPE”) is commonly used in making orthopaedic implants, such as artificial hip joints. In recent years, it has become increasingly apparent that tissue necrosis and osteolysis at the interface of the orthopaedic implant and the host bone are primary contributors to the long-term loosening failure of prosthetic joints. It is generally accepted by orthopaedic surgeons and biomaterials scientists that this tissue necrosis and osteolysis is due, at least in part, to the presence of microscopic particles of UHMWPE produced during the wear of the UHMWPE components. The reaction of the body to these particles includes inflammation and deterioration of the tissues, particularly the bone to which the orthopaedic implant is anchored. Eventually, the orthopaedic implant becomes painful and/or loose and must be replaced.

In order to increase the useful life of orthopaedic implants having UHMWPE parts, several attempts have been made to increase the wear resistance of the UHMWPE, thereby decreasing the number of wear particles that can cause tissue necrosis and/or osteolysis. One method for increasing the wear resistance of UHMWPE utilizes exposure to high-energy radiation, such as gamma radiation, in an inert or reduced-pressure atmosphere to induce cross-linking between the polyethylene molecules. This cross-linking creates a three-dimensional network of polyethylene molecules within the polymer which renders it more resistant to wear, such as adhesive wear. However, the free radicals formed upon irradiation of UHMWPE can also participate in oxidation reactions which reduce the molecular weight of the polymer via chain scission, leading to degradation of physical properties, embrittlement, and a significant increase in wear rate. Moreover, the three-dimensional network produced by the cross-linking reaction can reduce the mechanical properties of the UHMWPE. There are several processes that have been developed to effectively and efficiently reduce the number of free radicals present in irradiated UHMWPE, all of which have met with varying degrees of success (see, e.g. U.S. Pat. No. 5,414,049).

A need therefore exists for an orthopaedic implant comprising UHMWPE having enhanced wear performance, and methods for producing and using the implant. The invention provides such an implant and such methods. These and other advantages of the invention, as well as additional inventive features, will be apparent from the description of the invention provided herein.

### BRIEF SUMMARY OF THE INVENTION

The invention provides a sterile medical implant or medical implant part comprising ultrahigh molecular weight polyethylene that has a molecular weight of about 400,000 atomic mass units or more, wherein the ultrahigh molecular weight polyethylene has a water content that is about 0.005 wt. % or more above the baseline water content of the ultrahigh molecular weight polyethylene.

The invention also provides a method for producing a medical implant or medical implant part which comprises the steps of (a) providing ultrahigh molecular weight polyethylene having a molecular weight of about 400,000 atomic mass units or more, (b) cross-linking at least a portion of the ultrahigh molecular weight polyethylene, (c) forming the ultrahigh molecular weight polyethylene into a medical implant or medical implant part, (d) contacting the medical implant or medical implant part with water such that the weight of the ultrahigh molecular weight polyethylene is increased by about 0.005 wt. % or more, and (e) sterilizing the medical implant or medical implant part after the completion of step (d).

The invention further provides a method for using a medical implant or medical implant part, which comprises the steps of (a) providing a medical implant or medical implant part comprising ultrahigh molecular weight polyethylene having a molecular weight of about 400,000 atomic mass units or more, (b) contacting the medical implant or medical implant part with water, (c) sterilizing the medical implant or medical implant part after the completion of step (b), and (d) positioning the sterilized medical implant or medical implant part in a patient.

The invention also provides a method for preparing a medical implant or medical implant part, which comprises the steps of (a) providing a medical implant or medical implant part comprising ultrahigh molecular weight polyethylene having a molecular weight of about 400,000 atomic mass units or more, and (b) soaking the medical implant or medical implant part at a pressure of about 200 kilopascal (kPa) or more in water.

### DETAILED DESCRIPTION OF THE INVENTION

The invention provides a sterile medical implant or medical implant part comprising ultrahigh molecular weight polyethylene that has a molecular weight of about 400,000 atomic mass units or more, wherein the ultrahigh molecular weight polyethylene has a water content that is about 0.005 wt. % or more above the baseline water content of the ultrahigh molecular weight polyethylene.

As utilized herein, the term “ultrahigh molecular weight polyethylene” refers to a polyethylene polymer having a weight average molecular weight of about 400,000 atomic mass units or more. Preferably, the ultrahigh molecular weight polyethylene has a weight average molecular weight of about 1,000,000 atomic mass units or more (e.g., about 2,000,000 atomic mass units or more, or about 3,000,000 atomic mass units or more). Typically, the weight average molecular weight of the ultrahigh molecular weight polyethylene is about 10,000,000 atomic mass units or less, more preferably about 6,000,000 atomic mass units or less. Preferably, at least a portion of the ultrahigh molecular weight polyethylene is cross-linked.

The medical implant or medical implant part can be any suitable medical implant or medical implant part. Suitable medical implants or medical implant parts include, but are not limited to, the acetabular cup, the insert or liner of the acetabular cup, or trunnion bearings (e.g., between the modular head and the stem) of artificial hip joints, the tibial plateau, patellar button (patello-femoral articulation), and trunnion or other bearing components of artificial knee joints, the talar surface (tibiotalar articulation) and other bearing components of artificial ankle joints, the radio-numeral joint, ulno-humeral joint, and other bearing components of artificial elbow joints, the glenoro-humeral articulation and other bearing components of artificial shoulder joints, intervertebral disk replacements and facet joint replacements for the spine, temporo-mandibular joints (jaw), and finger joints.

The ultrahigh molecular weight polyethylene of medical implants and medical implant parts typically contains a low level of moisture as a result of the process employed to form the medical implant or medical implant part. Thus, in this respect, the ultrahigh molecular weight polyethylene is said to have a “baseline” water content. The baseline water content of the ultrahigh molecular polyethylene typically is the water content of the ultrahigh molecular weight polyethylene at conditions of about 50% relative humidity (RH) and a temperature of about 20° C. to about 25° C. (i.e., room or ambient temperature).

The ultrahigh molecular weight polyethylene of the inventive medical implant or medical implant part has an increased water content as compared to the baseline water content. In this respect, the inventive medical implant or medical implant part comprises ultrahigh molecular weight polyethylene having a water content that is about 0.005 wt. % or more (e.g., about 0.0075 wt. % or more, about 0.01% or more, or about 0.015 wt. % or more) above the baseline water content of the ultrahigh molecular weight polyethylene. Most preferably, the water content of the ultrahigh molecular weight polyethylene is about 0.02 wt. % or more (e.g., about 0.025 wt. % or more, about 0.03 wt. % or more, or about 0.04 wt. % or more) above the baseline water content of the ultrahigh molecular weight polyethylene. Preferably, the water content of the ultrahigh molecular weight polyethylene is not more than about 0.05 wt. % above the baseline water content of the ultrahigh molecular weight polyethylene. It is believed that increasing the water content of the ultrahigh molecular weight polyethylene of a medial implant or medical implant part increases the wear performance of the medical implant or medical implant part formed therefrom.

The medical implant or medical implant part of the invention is “sterile” in that it is free of contaminating bacteria or other microorganisms (e.g., viruses, parasites, etc.). The medical implant or medical implant part can be sterilized using any suitable technique. Preferably, the medical implant or medical implant part is sterilized using a non-irradiative method so as to avoid the formation of additional free radicals in irradiated ultrahigh molecular weight polyethylene. Suitable non-irradiative sterilization techniques include, but are not limited to, gas plasma or ethylene oxide methods known in the art. For example, the medical implant or medical implant part can be sterilized using a gas plasma sterilizing process, as described in U.S. Pat. Nos. 5,413,760 and 5,603,895. In embodiments where non-cross-linked UHMWPE is used, the medical implant or medical implant part can be sterilized using an irradiative process.

The medical implant or medical implant part can be packaged in any suitable packaging material, so long as the sterility of the medical implant or medical implant part is maintained until the packaging material is breached. The medical implant or medical implant part desirably is packaged in an inert atmosphere, wherein the packaging material is an air-impermeable packaging material.

The invention also provides a method for producing a medical implant or medical implant part which comprises the steps of (a) providing ultrahigh molecular weight polyethylene having a molecular weight of about 400,000 atomic mass units or more, (b) cross-linking at least a portion of the ultrahigh molecular weight polyethylene, (c) forming the ultrahigh molecular weight polyethylene into a medical implant or medical implant part, (d) contacting the medical implant or medical implant part with water such that the weight of the ultrahigh molecular weight polyethylene is increased by about 0.005 wt. % or more, and (e) sterilizing the medical implant or medical implant part after the completion of step (d).

Prior to forming the ultrahigh molecular weight polyethylene into the medical implant or medical implant part of the invention, the ultrahigh molecular weight polyethylene is typically sized and shaped so that a medical implant or medical implant part can easily be formed therefrom via conventional machining or compression molding methods. The ultrahigh molecular weight polyethylene preferably is in the form of a shaped article which has been consolidated, such as by ram extrusion or compression molding of ultrahigh molecular weight polyethylene resin particles into rods, sheets, blocks, slabs, or the like. The ultrahigh molecular weight polyethylene may be in the form of commercially available ultrahigh molecular weight polyethylene articles, such as GUR 1050 ram extruded ultrahigh molecular weight polyethylene rods (average molecular weight of about 5,000,000 to about 6,000,000 atomic mass units) from PolyHi Solidur (Fort Wayne, Indiana). Preferably, the ultrahigh molecular weight polyethylene articles do not contain stabilizers, antioxidants, or other chemical additives which may have potential adverse effects in medical applications.

The cross-linking of the ultrahigh molecular weight polyethylene can be carried out in any suitable manner. Preferably, the ultrahigh molecular weight polyethylene is exposed to radiation, such as gamma radiation, to induce cross-linking between the polyethylene molecules. The ultrahigh molecular weight polyethylene can be irradiated using any suitable method. For example, the ultrahigh molecular weight polyethylene can be irradiated by exposure to a suitable amount of gamma, x-ray, or electron beam radiation. Preferably, the ultrahigh molecular weight polyethylene is irradiated by exposure to about 0.5 to about 10 Mrad (e.g., about 1.5 to about 6 Mrad) of gamma radiation using methods known in the art. While the ultrahigh molecular weight polyethylene can be exposed to amounts of radiation falling outside of the aforementioned range, such amounts of radiation tend to produce ultrahigh molecular weight polyethylene with unsatisfactory properties. In particular, radiation doses of less than about 0.5 Mrad generally provide insufficient cross-linking of the ultrahigh molecular weight polyethylene to provide the desired increase in wear properties. Furthermore, while doses of greater than 10 Mrad may be used, the additional improvement in wear properties of the ultrahigh molecular weight polyethylene that is achieved generally is offset by the increased brittleness of the ultrahigh molecular weight polyethylene due to higher levels of cross-linking.

The ultrahigh molecular weight polyethylene desirably is irradiated in an inert or reduced-pressure atmosphere. Irradiating the ultrahigh molecular weight polyethylene in an inert (i.e., non-oxidizing) or reduced-pressure atmosphere reduces the effects of oxidation and chain scission reactions which can occur during irradiation in an oxidative atmosphere. Typically, the ultrahigh molecular weight polyethylene is placed in an oxygen-impermeable package during the irradiation step. Suitable oxygen-impermeable packaging materials include, but are not limited to, aluminum, polyester coated metal foil (e.g., the Mylar® product available from DuPont Teijin Films), polyethylene terephthalate, and poly(ethylene vinyl alcohol). In order to further reduce the amount of oxidation which occurs during the irradiation of the ultrahigh molecular weight polyethylene, the oxygen-impermeable packaging may be evacuated (e.g., the pressure within the packaging may be reduced below the ambient atmospheric pressure) and/or flushed with an inert gas (e.g., nitrogen, argon, helium, or mixtures thereof) after the ultrahigh molecular weight polyethylene has been placed therein.

The medical implant or medical implant part can be formed from the ultrahigh weight polymer, typically consolidated articles (e.g., rods) of ultrahigh molecular weight polyethylene, by any suitable method. Suitable methods include machining and compression molding methods. Preferably, the medical implant or medical implant part is machined from consolidated articles of ultrahigh molecular weight polyethylene.

The inventive method involves contacting the medical implant or medical implant with water. Any portion of the medical implant or medical implant part can be contacted with water. Preferably, the entire medical implant or medical implant part is contacted with water. The UHMWPE that comprises the medical implant or medical implant part can be contacted with water before it is formed into the medical implant or medical implant part. Alternatively, contact with water can occur after the UHMWPE has been machined into the medical implant or medical implant part. The medical implant or medical implant part can be contacted with water using any suitable technique. Such methods include, but are not limited to, soaking, spraying, exposing to steam, and packaging a medical implant or medical implant part in sterile water. The medical implant or medical implant part preferably is soaked in water.

The medical implant or medical implant part is contacted with water such that the weight of the ultrahigh molecular weight polyethylene is increased by about 0.005 wt. % or more (e.g., about 0.0075 wt. % or more, about 0.01% or more, or about 0.015 wt. % or more). Most preferably, the weight of the ultrahigh molecular weight polyethylene is increased as a result of contacting the medical implant or medical implant part with water by about 0.02 wt. % or more (e.g., about 0.025 wt. % or more, about 0.03 wt. % or more, or about 0.04 wt. % or more). Preferably, the water content of the ultrahigh molecular weight polyethylene is increased by about 0.05 wt. % or less.

Thus, the medical implant or medical implant part is contacted with water for a time sufficient to introduce enough water into the medical implant or medical implant part to increase the weight of the ultrahigh molecular weight polyethylene by a desired amount. When the medical implant or medical implant part is soaked in water, for example, the medical implant or medical implant part desirably is soaked in water for a period of about 2 days or more (e.g., about 3 days or more, about 5 days or more, or about 10 days or more). Typically, the medical implant or medical implant part is soaked in water for about 40 days or less (e.g., about 30 days or less, about 20 days or less, or about 15 days or less).

The medical implant or medical implant part can be contacted with water at any suitable temperature or pressure. The contacting of the medical implant or medical implant part with water at higher temperatures and/or higher pressure can increase the rate at which water is introduced into the medical implant or medical implant part.

The medical implant or medical implant part can be contacted with any suitable type of water, e.g., tap water, distilled water, deionized water, etc. Generally, the medical implant or medical implant part is contacted with sterile water. Water suitable for medical or pharmaceutical applications is available in varying degrees of sterility and purity. Examples of suitable types of sterile water include double-distilled water, deionized water, water purified on a Millipore Q system (“Milli-Q™ water”), and bottled HPLC grade water (available from Sigma-Aldrich).

The medical implant or medical implant part is sterilized using any suitable methods. Sterilization of the medical implant or medical implant part can occur at any suitable time, typically following contacting the medical implant or medical implant part with water. In this respect, the medical implant or medical implant part can be sterilized immediately after the medical implant or medical implant part has been contacted with water. Alternatively, the medical implant or medical implant part can be further modified and/or packaged prior to sterilization. The medical implant or medical implant part can be packaged, after the medical implant or medical implant part has been sterilized, in packaging material that maintains the sterility of the medical implant or medical implant part until the packaging material is breached. Alternatively, the medical implant or medical implant part can be packaged, after being contacted with water and before sterilization, in packaging material that maintains the sterility of the medical implant or medical implant part until the packaging material is breached. Moreover, the medical implant or medical implant part can be contacted with water and sterilized in a single step by, for example, packaging the medical implant or medical implant part in sterile water in packaging material that maintains the sterility of the medical implant or medical implant part until the packaging material is breached.

The invention further provides a method for using a medical implant or medical implant part, which comprises the steps of (a) providing a medical implant or medical implant part comprising ultrahigh molecular weight polyethylene having a molecular weight of about 400,000 atomic mass units or more, (b) contacting the medical implant or medical implant part with water, (c) sterilizing the medical implant or medical implant part after the completion of step (b), and (d) positioning the sterilized medical implant or medical implant part in a patient. The ultrahigh molecular weight polyethylene, the medical implant or medical implant part, the contacting of the medical implant or medical implant part with water, and the sterilizing of the medical implant or medical implant part are described above in connection with other embodiments of the invention, which descriptions also are applicable to those same aspects of the aforesaid inventive method of using a medical implant or medical implant part.

In accordance with the inventive method of using a medical implant or medical implant part, the medical implant or medical implant part that has been contacted with water (“hydrated medical implant or medical implant part”) is positioned in a patient using any suitable technique. Preferably, the sterilized medical implant or medical implant part is positioned in a patient using surgical methods known in the art (see, e.g., DePuy Orthopaedics, Inc., brochures entitled “Duraloc® Acetabular Cup System” and “Duraloc® Constrained Liner”).

Contacting the medical implant or medical implant part with water in accordance with the inventive method enhances the wear performance of the medical implant or medical implant part by decreasing the wear rate thereof. Thus, the hydrated medical implant or medical implant part of the invention has an in vivo wear rate that is less than the in vivo wear rate of the same medical implant or medical implant part that has not been contacted with water. Preferably, the hydrated medical implant or medical implant part of the invention has a wear rate that is decreased by about 10% or more (e.g., about 20% or more, about 40% or more, about 60% or more, or about 80% or more) as compared to the wear rate of the same medical implant or medical implant part that has not been contacted with water. Moreover, the hydrated medical implant or medical implant part of the invention is contacted with water such that the weight of the ultrahigh molecular weight polyethylene is increased by about 0.005 wt. % or more (e.g., about 0.0075 wt. % or more, about 0.01% or more, or about 0.015 wt. % or more). Most preferably, the weight of the ultrahigh molecular weight polyethylene is increased as a result of contacting the medical implant or medical implant part with water by about 0.02 wt. % or more (e.g., about 0.025 wt. % or more, about 0.03 wt. % or more, or about 0.04 wt. % or more). Preferably, the water content of the ultrahigh molecular weight polyethylene is increased by about 0.05 wt. % or less.

The rate at which water is introduced, and the amount of water introduced, into the medical implant or medical implant part can be increased by subjecting the medical implant or medical implant part to a pressurized soak in water. Thus, the invention further provides a method for preparing a medical implant or medical implant part which comprises the steps of (a) providing a medical implant or medical implant part comprising ultrahigh molecular weight polyethylene having a molecular weight of about 400,000 atomic mass units or more, and (b) soaking the medical implant or medical implant part at a pressure of about 200 kilopascal (kPa) or more in water. The ultrahigh molecular weight polyethylene, the medical implant or medical implant part, the contacting of the medical implant or medical implant part with water, and the soaking of the medical implant or medical implant part in water are described above in connection with other embodiments of the invention, which descriptions also are applicable to those same aspects of the aforesaid inventive method of preparing a medical implant or medical implant part using an elevated pressure water soak.

Any suitable technique and/or apparatus can be used to increase the ambient pressure while the medical implant or medical implant part is soaked in water. For example, the soaking medical implant or medical implant part can be placed in a pressurized chamber. The medical implant or medical implant part desirably is soaked at a pressure that is greater than atmospheric pressure (i.e., greater than about 100 kPa of pressure). Thus, the medical implant or medical implant part preferably is soaked at a pressure of about 200 kPa or more (e.g., about 500 kPa or more, about 1000 kPa (i.e., 1 megapascal (mPa)) or more, about 2 mPa or more, or about 3 mPa or more) in water. More preferably, the medical implant or medical implant part is soaked at a pressure of about 5 mPa or more (e.g., about 6 mPa or more, about 7 mPa or more, or about 8 mPa or more) in water.

In general, soaking the medical implant or medical implant part under elevated pressure in water decreases the length of soaking time required to increase the water content of the medical implant or medical implant to levels sufficient to impart enhanced wear performance. The medical implant or medical implant part desirably is soaked in water under elevated pressure for a period of about 2 days to about 10 days (e.g., about 3 days, about 5 days, or about 7 days).

Soaking the medical implant or medical implant part at a pressure of about 200 kPa or more in sterile water desirably produces about a 3-fold or more (e.g., about 5-fold or more, or about 10-fold or more) increase in the water content of the ultrahigh molecular weight polyethylene as compared to the same medical implant or medical implant part that has been soaked at atmospheric pressure in water. Alternatively, the medical implant or medical implant part is contacted with water such that the weight of the ultrahigh molecular weight polyethylene is increased by the amounts described above with respect to other embodiments of the invention. The soaking of the medical implant or medical implant part under increased pressure in water preferably enhances the wear performance of the medical implant or medical implant part by decreasing the wear rate thereof, as also described above with respect to other embodiments of the invention.

Typically, soaking the medical implant or medical implant part at elevated pressure in water is performed at a temperature above room temperature (typically about 25° C.) but below the temperature at which water boils (typically about 100° C.). Most preferably, the pressurized soak is performed at a temperature of about 80° C. to about 95° C.

The medical implant or medical implant part can be additionally processed as described above with respect to other embodiments of the invention. For example, the medical implant or medical implant part desirably is sterilized as previously discussed.

### EXAMPLE

This example further illustrates the invention but, of course, should not be construed as in any way limiting its scope. This example demonstrates a method for preparing a medical implant or medical implant part.

Commercially available ultrahigh molecular weight polyethylene was cross-linked by exposure to high energy radiation. The UHMWPE then was machined into six liners of the acetabular cup, which subsequently were cleaned and divided into two groups. One group of liners was soaked in deionized water for approximately 28 days, while the other group was not contacted with water.

The wear performance of the hydrated and non-hydrated liners was tested on an 8-station hip joint simulator (MTS Systems Corp., Eden Prairie, Minn.) using the Paul-type physiological loading (i.e., 2000 N max, +/−23° biaxial rocking motion at 1 Hz). The position of the acetabular cup implant was inverted, such that the femoral head was positioned above the liner in the simulator. The interface between the implant and the simulator was lubricated with 500 ml of 90% bovine serum (HyClone Lab, Utah). Simulation was performed for 2.5 million cycles. Wear was assessed by measuring the weight loss of the implant every 500,000 cycles, correcting for fluid absorption using soak control liners that were not subject to simulation.

The wear rate for acetabular cup liners not soaked in water prior to the wear performance test was 15.81+/−2.86 mg/million cycles. In contrast, the acetabular cup liners subjected to the 28-day soak in water prior to the wear performance test exhibited a wear rate of 5.46+/−0.03 mg/million cycles, which corresponds to about a 65% decrease in wear rate.

The results of this example demonstrate that the invention provides an improved medical implant. Indeed, the results demonstrate that the contacting of the medical implant or medical implant part with water can decrease the wear rate of the medical implant or medical implant part by about 10% or more.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A sterile medical implant or medical implant part comprising ultrahigh molecular weight polyethylene that has a molecular weight of about 400,000 atomic mass units or more, wherein the ultrahigh molecular weight polyethylene has a water content that is about 0.005 wt. % or more above the baseline water content of the ultrahigh molecular weight polyethylene.

2. The sterile medical implant or medical implant part of claim 1, wherein the ultrahigh molecular weight polyethylene has a molecular weight of about 1,000,000 atomic mass units or more.

3. The sterile medical implant or medical implant part of claim 1, wherein at least a portion of the ultrahigh molecular weight polyethylene is cross-linked.

4. The sterile medical implant or medical implant part of claim 1, wherein the ultrahigh molecular weight polyethylene has a water content that is about 0.02 wt. % or more above the baseline water content of the ultrahigh molecular weight polyethylene.

5. The sterile medical implant or medical implant part of claim 1, wherein the sterile medical implant or medical implant part is packaged in an air-impermeable or air-permeable packaging material that maintains the sterility of the medical implant or implant part until the packaging material is breached.

6. A method for producing a medical implant or medical implant part, the method comprising the steps of:
(a) providing ultrahigh molecular weight polyethylene, wherein the ultrahigh molecular weight polyethylene has a molecular weight of about 400,000 atomic mass units or more,
(b) cross-linking at least a portion of the ultrahigh molecular weight polyethylene,
(c) forming the ultrahigh molecular weight polyethylene into a medical implant or medical implant part,
(d) contacting the medical implant or medical implant part with water such that the weight of the ultrahigh molecular weight polyethylene is increased by about 0.005 wt. % or more, and
(e) sterilizing the medical implant or medical implant part after the completion of step (d).

7. The method of claim 6, wherein the method further comprises packaging the medical implant or medical implant part after the completion of step (e) in packaging material that maintains the sterility of the medical implant or medical implant part until the packaging material is breached.

8. The method of claim 6, wherein the method further comprises packaging the medical implant or medical implant part after the completion of step (d) and before the completion of step (e) in packaging material that maintains the sterility of the medical implant or medical implant part until the packaging material is breached.

9. The method of claim 6, wherein the method further comprises packaging the medical implant or medical implant part in sterile water.

10. The method of claim 6, wherein the ultrahigh molecular weight polyethylene has a molecular weight of about 1,000,000 atomic mass units or more.

11. The method of claim 6, wherein contacting the medical implant or medical implant part with water comprises soaking the medical implant or medical implant part in water.

12. A method for using a medical implant or medical implant part, the method comprising the steps of:
(a) providing a medical implant or medical implant part comprising ultrahigh molecular weight polyethylene having a molecular weight of about 400,000 atomic mass units or more,
(b) contacting the medical implant or medical implant part with water,
(c) sterilizing the medical implant or medical implant part after the completion of step (b), and
(d) positioning the sterilized medical implant or medical implant part in a patient.

13. The method of claim 12, wherein the ultrahigh molecular weight polyethylene has a molecular weight of about 1,000,000 atomic mass units or more.

14. The method of claim 12, wherein at least a portion of the ultrahigh molecular weight polyethylene is cross-linked.

15. The method of claim 12, wherein the medical implant or medical implant part has an in vivo wear rate that is less than the in vivo wear rate of the same medical implant or medical implant part that has not been contacted with water.

16. The method of claim 12, wherein the medical implant or medical implant part has a wear rate that is decreased by about 10% or more as compared to the wear rate of the same medical implant or medical implant part that has not been contacted with water.

17. The method of claim 12, wherein the medical implant or medical implant part is contacted with water such that the weight of the ultrahigh molecular weight polyethylene is increased by about 0.005 wt. % or more.

18. The method of claim 12, wherein contacting the medical implant or medical implant part with water comprises soaking the medical implant or medical implant part in water.

19. A method for preparing a medical implant or medical implant part, the method comprising the steps of:
(a) preparing a medical implant or medical implant part comprising ultrahigh molecular weight polyethylene having a molecular weight of about 400,000 atomic mass units or more, and
(b) soaking the medical implant or medical implant part at a pressure of about 200 kilopascal (kPa) or more in water.

20. The method of claim 19, wherein the ultrahigh molecular weight polyethylene has a molecular weight of about 1,000,000 atomic mass units or more.

21. The method of claim 19, wherein at least a portion of the ultrahigh molecular weight polyethylene is cross-linked.

22. The method of claim 19, wherein soaking the medical implant or medical implant part at a pressure of about 200 kPa or more in sterile water produces about a 3-fold or more increase in the water content of the ultrahigh molecular weight polyethylene as compared to the same medical implant or medical implant part that has been soaked at atmospheric pressure in water.

23. The method of claim 19, wherein the medical implant or medical implant part is soaked at a pressure of about 200 kPa or more in water such that the weight of the ultrahigh molecular weight polyethylene is increased by about 0.005 wt. % or more.

24. The method of claim 19, wherein the medical implant or medical implant part has an in vivo wear rate that is less than the in vivo wear rate of the same medical implant or medical implant part that has not been contacted with water.

25. The method of claim 19, wherein the medical implant or medical implant part has a wear rate that is decreased by about 10% or more as compared to the wear rate of the same medical implant or medical implant part that has not been soaked at a pressure of about 200 kPa or more in water.

26. The method of claim 19, wherein step (b) is performed at a temperature of about 80° C. to about 95° C.

27. The method of claim 19, wherein the method further comprises:
(c) sterilizing the medical implant or medical implant part before the medical implant or medical implant part is contacted with water, and
(d) packaging the medical implant or medical implant part after the medical implant or medical implant part is contacted with water in packaging material that maintains the sterility of the medical implant or medical implant part until the packaging material is breached.

28. The method of claim 19, wherein the method further comprises:
(c) packaging the medical implant or medical implant part after the completion of step (b), and
(d) sterilizing the packaged medical implant or medical implant part, wherein the medical implant or medical implant part is packaged in packaging material that maintains the sterility of the medical implant or medical implant part until the packaging material is breached.
